(19) United States
(12) Patent Application Publication
(10) Pub. No.: US 2012/0320481 A1
(43) Pub. Date: Dec. 20, 2012

(54) Protection System

(75) Inventors: Nickole Gagne, South Portland, ME (US); Steve Macaluso, Scarborough, ME (US); Tyler Daigle, Portland, ME (US); Taeghyun Kang, Scarborough, ME (US)

(73) Assignee: FAIRCHILD SEMICONDUCTOR CORPORATION, San Jose, CA (US)

(21) Appl. No.: 13/488,639

(22) Filed: Jun. 5, 2012

Related U.S. Application Data
(60) Provisional application No. 61/497,666, filed on Jun. 16, 2011.

(51) Int. Cl. H02H 3/24; H02H 3/20

(52) U.S. Cl. 361/90; 361/92

(57) ABSTRACT

Devices, systems and methods are provided for protecting electronic circuitry from voltage transients including undervoltage transients in a supply voltage. The device may include a first low voltage isolated transistor coupled in forward bias with respect to a power supply and a second low voltage isolated transistor coupled in series with the first low voltage isolated transistor and in reverse bias with respect to the power supply voltage. The device may further include a resistor coupled between a gate of the first low voltage isolated transistor and the power supply, the resistor configured to limit current flow to the gate of the first low voltage isolated transistor during an overvoltage event.

### CROSS REFERENCE TO RELATED APPLICATIONS

This application claims the benefit of U.S. provisional patent application Ser. No. 61/497,666 filed Jun. 16, 2011, which is incorporated fully herein by reference.

### FIELD

The present disclosure relates generally to device protection systems, and, more particularly, to an undervoltage and overvoltage protection system.

### BACKGROUND

Power supplies often have transient voltage events that can cause significant damage to an electronic device receiving power from the power supply. While most devices include overvoltage transient protection circuits (e.g., electrostatic discharge circuits (ESD), ground fault tolerant circuits, etc.), undervoltage transient events often go undetected and unmanaged. For example, an undervoltage transient event may occur when a power connector, jack, or adapter is plugged in to the electronic device “backward” or in reverse polarity. During the undervoltage transient event, large negative currents may begin to flow through the device to the power supply, and the overvoltage transient protection circuit, the electronic device, or both may be damaged in the process.

### SUMMARY

Generally, this disclosure provides a protection system and method for both undervoltage and overvoltage protection for an electronic device/circuitry coupled to a power rail. In general, the protection system includes undervoltage protection circuitry that operates to block undervoltage transient events that would otherwise cause significant current to flow from a reference potential to the power supply. In addition, overvoltage protection circuitry is provided in a stacked arrangement with the undervoltage protection circuitry to provide significant positive high voltage tolerance. The undervoltage protection circuitry of the present disclosure may utilize conventional low voltage transistor devices to handle undervoltage or overvoltage events. The undervoltage protection circuitry of the present disclosure may also be coupled to a wide variety of power supply configurations for providing voltage transient protection for electronic devices/circuitry while allowing use of conventional high voltage overvoltage protection circuitry and facilitating steady-state operation of the electronic devices/circuitry.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 illustrates a protection system consistent with various embodiments of the present disclosure;

FIG. 2 illustrates a schematic diode representation of the protection system of FIG. 1;

FIG. 3 illustrates comparative graphs of current draw according to one embodiment of the present disclosure; and

FIG. 4 illustrates a flowchart of operations of another exemplary embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, the present disclosure provides a protection system (and various methods) to provide both undervoltage and overvoltage protection for an electronic device/circuitry coupled to a power rail. In general, the protection system includes undervoltage protection circuitry that operates to block undervoltage transient events that would otherwise cause significant current to flow from a reference potential to the power supply. In addition, overvoltage protection circuitry is provided in a stacked arrangement with the undervoltage protection circuitry to provide significant positive high voltage tolerance. Advantageously, the undervoltage protection circuitry of the present disclosure may utilize conventional low voltage transistor devices to handle undervoltage or overvoltage events. Also advantageously, the undervoltage protection circuitry of the present disclosure may be coupled to a wide variety of power supply configurations for providing voltage transient protection for electronic devices/circuitry while allowing use of conventional high voltage overvoltage protection circuitry and facilitating steady-state operation of the electronic devices/circuitry.

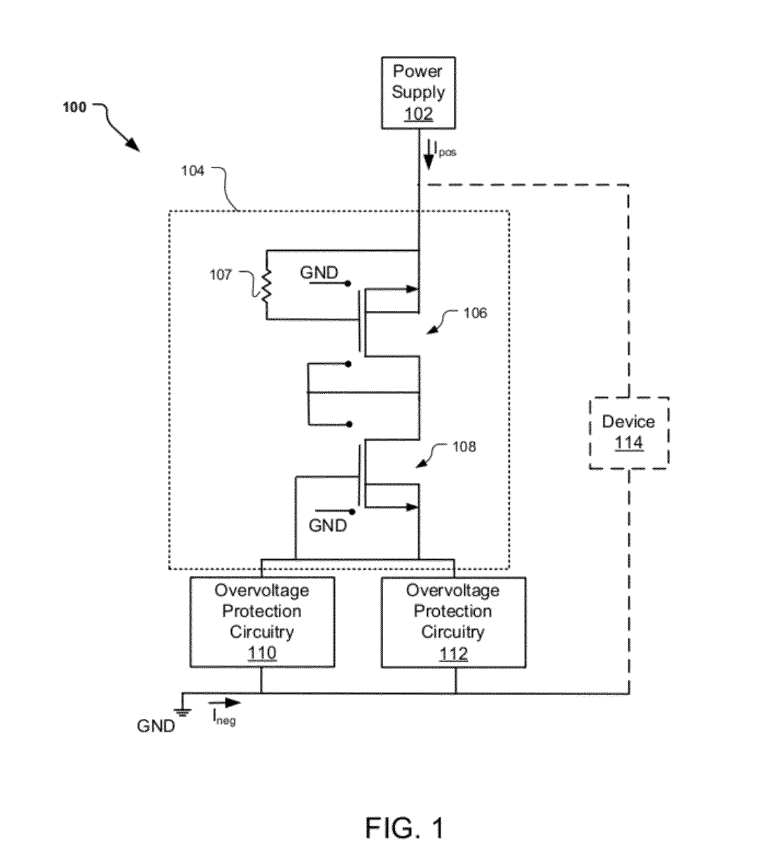

FIG. 1 illustrates a protection system 100 consistent with various embodiments of the present disclosure. As a general overview, the protection system 100 includes undervoltage protection circuitry 104 coupled to power supply 102 and to a reference (GND) potential through overvoltage protection circuitry 110 and 112. Electronic device/circuitry 114 may be coupled to the power supply 102 in parallel with the undervoltage protection circuitry 104 and, in some embodiments, in parallel with the combination of the undervoltage protection circuitry 104 and the overvoltage protection circuitry 110, 112. The term “undervoltage,” as used herein, means a voltage event that is below a ground (GND) or reference potential associated with the power supply 102 which is also in common with the electronic device/circuitry 114 as well as the undervoltage protection circuitry 104 and the over voltage protection circuitry 110 and 112, and may include, for example, a negative voltage transient event. During such a negative voltage transient event, a negative current may flow in the direction depicted as I_{neg} in FIG. 1 (i.e., from GND to power supply 102). The term “overvoltage,” as used herein, means a voltage event that is above a steady-state DC potential associated with the power supply 102, and may include, for example a positive voltage transient event. During normal operation and during an overvoltage event, a positive current may flow in the direction depicted as Iₚₒₛ in FIG. 1.

The overvoltage protection circuitry 110 and 112 may each include conventional ESD circuitry, such as diode stacks, silicon controlled rectifiers (SCRs), active clamps, etc., used to shunt overvoltage transient conditions on the power supply 102 from the electronic device/circuitry 114. The overvoltage protection circuitry 110 and 112 may each include high voltage negative metal oxide semiconductor (NMOS) transistors having a relatively large breakdown voltage capable of clamping overvoltage events. The electronic device/circuitry 114 may include, for example, other circuits and/or systems associated with an integrated circuit (IC), system on chip (SoC), etc. In general, the device 114 is undervoltage and overvoltage tolerant to a certain degree.

The undervoltage protection circuitry 104 includes NMOS transistors 106 and 108. The source of transistor 106 is coupled to power supply 102 and the drain of transistor 106 is coupled to the drain of transistor 108. The source of transistor 108 is coupled to overvoltage protection circuitry 110 and 112 (110 and 112 are coupled in parallel to transistor 108). The substrate terminals of transistors 106 and 108 are each coupled to the reference potential (GND) and the n-type isolation terminals are coupled together, as shown. Protection circuitry 104 may also include resistor 107 coupled between the gate of transistor 106 and the power supply 102. Resistor 107 generally operates to protect the gate oxide of the transistor 106 under noise or transient voltage spike conditions. Resistor 107 limits current flow to the gate of transistor 106 which creates a difference in voltage potentials between the gate and source/bulk connections of transistor 106. The difference in potentials protects the gate oxide by allowing current conduction to occur mostly through parasitic bulk to drain diode instead of the channel surface of the MOS device.

In one embodiment, transistors 106 and 108 each include a low voltage isolated NMOS transistor, diode connected as shown. Generally, an “isolated” device means that the drain/bulk and source/bulk junction diodes of the device are isolated, physically and electrically, from the containing substrate. For example, an isolated device may include an additional n-type diffusion to p-type substrate junction diode with a large breakdown characteristic voltage. Since the bulk junctions of isolated transistors 106 and 108 are coupled to the power supply 102, an additional bulk-to-drain diode is formed in parallel with the diode connected transistor.

Advantageously, the transistors 106 and 108 may be low voltage devices (i.e., these devices need not be high voltage tolerant), even though the system 100 may be high voltage tolerant. To that end, transistor 106 is forward biased with respect to the power supply 102, and transistor 108 is reverse biased with respect to power supply 102. Thus, the maximum VGS, VGD or VDS voltage for transistor 106 is limited to a conventional NMOS threshold voltage (Vₜ), approximately 0.7 Volts. The reverse breakdown of transistor 108, a conventional isolated NMOS device, will limit VGS, VGD or VDS to a low voltage drain-source-substrate breakdown voltage (BVDSS), approximately 7.2 Volts. Of course, these parameters can be changed by adjusting the size of the transistors, or by further biasing the transistors, as is known in the art. In general, the breakdown voltage of transistors 106 may be approximately equal to the undervoltage tolerance of the device 114, and the breakdown voltage of the transistor 108 and the overvoltage protection circuitry 110 and 112, in combination, may be approximately equal to the overvoltage tolerance of the device 114.

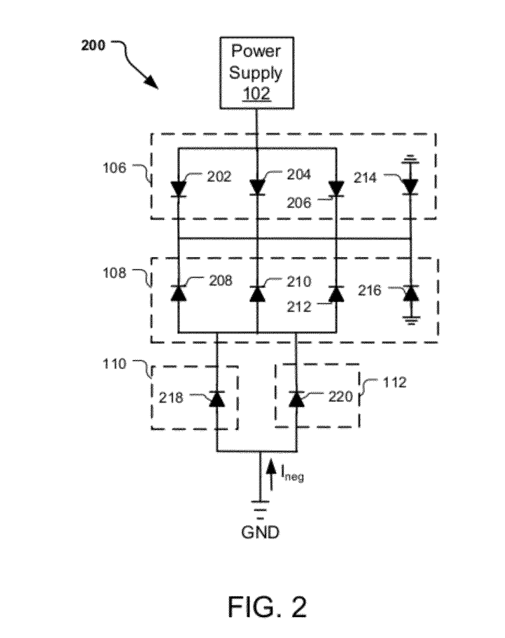

FIG. 2 illustrates a schematic diode representation 200 of the protection circuitry of FIG. 1. Low voltage transistor 106 is represented by four diodes: diode 202 represents the diode-connected transistor, diode 204 represents the bulk-to-drain diode of the transistor, diode 206 represents the P/N junction between the bulk and isolation layer of the transistor, and diode 214 represents the P/N junction between the isolation layer and the p-type substrate. The diodes 202, 204 and 206 are in forward bias and diode 214 is in reverse bias with respect to the power supply 102 (and diodes 202, 204, and 206 are in reverse bias and diode 214 is in forward bias with respect to negative current I_{neg}). Low voltage transistor 108 is represented by four diodes: diode 208 represents the diode-connected transistor, diode 210 represents the bulk-to-drain diode of the transistor, diode 212 represents the P/N junction between the bulk and isolation layer of the transistor, and diode 216 represents the P/N junction between the isolation layer and the p-type substrate. Diodes 208, 210, 212 and 216 are in reverse bias with respect to the power supply 102 (and forward bias with respect to negative current I_{neg}). Overvoltage protection circuitry 110 is represented by diode 218, which generally has a larger voltage tolerance than the diodes of the transistors 106 and 108 (i.e., diode 218 is a high voltage device). Similarly, overvoltage protection circuitry 112 is represented by diode 220, which generally has a larger voltage tolerance than the diodes of the transistors 106 and 108 (i.e., diode 220 is a high voltage device). Diode 214, 216, 218 and 220 are in reverse bias with respect to the power supply 102 (and forward bias with respect to negative current I_{neg}).

In operation, during an undervoltage transient event, the overvoltage protection circuitry 110 and 112 and the transistor 108 are in forward bias with respect to negative current I_{neg}, but transistor 106 remains in reverse bias to I_{neg} until the breakdown voltage of transistor 106 is exceeded. As a result, the system 100 significantly limits I_{neg} until the breakdown voltage of 106 is exceeded. During an overvoltage event, transistor 106 is in forward bias and transistor 108 and overvoltage protection circuitry 110 and 112 are in reverse bias. Thus, positive current (Iₚₒₛ) is limited until the breakdown voltage of transistor 108 and overvoltage protection circuitry 110 and 112 are exceeded. Once the breakdown voltages of transistor 108 and overvoltage protection circuitry 110 and 112 are exceeded, the overvoltage protection circuitry 110 and 112 operates to shunt current to ground, thus protecting device 114 from large current during overvoltage events. Accordingly, this stacked arrangement provides both negative transient and overvoltage current limiting abilities.

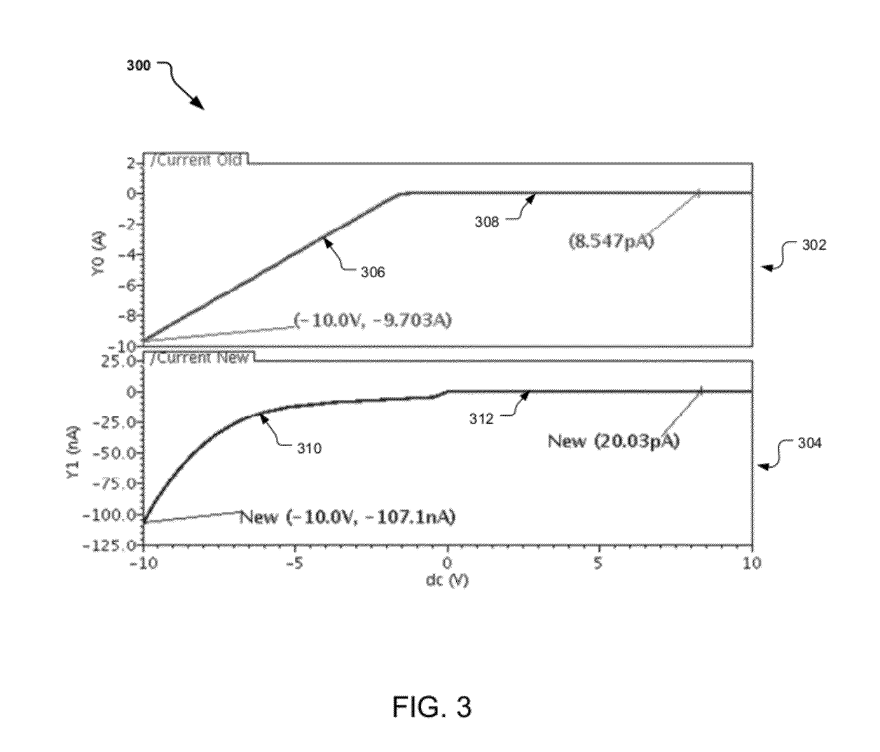

FIG. 3 illustrates comparative plots 300 of current draw according to one embodiment of the present disclosure. Plot 302 represents a current draw, during an undervoltage event, of the overvoltage protection circuitry 110, 112 of FIG. 1 alone. In other words, the plot 302 represents the current draw through convention overvoltage protection circuits, without the benefit of the undervoltage protection circuitry provided herein, during an undervoltage event. As can be seen, as the DC voltage swings negative (between 10 and −10 Volts in this example), almost 10 Amps of negative current flows from the reference potential to the positive voltage rail (or power supply). In contrast, plot 304 represents current draw, during an undervoltage event, of the overvoltage protection circuitry 110, 112 and the undervoltage protection circuitry 104 of FIG. 1. As can be seen, as the DC voltage swings negative (between 10 and −10 Volts in this example), only 100 nanoamps of negative current flows from the reference potential to the positive voltage rail (or power supply). Thus, current draw during an undervoltage event is significantly reduced by many orders of magnitude.

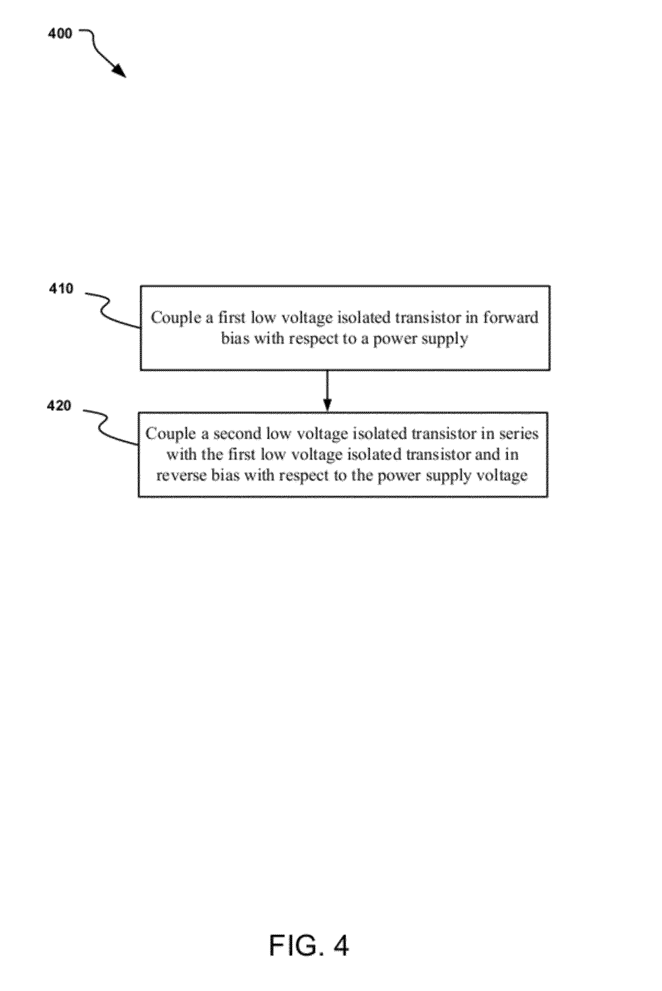

FIG. 4 illustrates a flowchart of operations 400 of an exemplary embodiment consistent with the present disclosure. At operation 410, a first low voltage isolated transistor is coupled in forward bias with respect to a power supply. At operation 420, a second low voltage isolated transistor is coupled in series with the first low voltage isolated transistor and in reverse bias with respect to the power supply voltage. In some embodiments, a resistor may be coupled between a gate of the first low voltage isolated transistor and the power supply, wherein the resistor is configured to limit current flow to the gate of the first low voltage isolated transistor during an overvoltage event.

Thus, the present disclosure provides devices, systems and methods for protecting electronic circuitry from voltage transients including undervoltage transients in a supply voltage. According to one aspect there is provided a voltage transient protection system. The system may include an undervoltage protection circuit coupled in parallel with electronic circuitry configured to receive a supply voltage from a power supply. The undervoltage protection circuit of this example may be configured to reduce undervoltage current resulting from an undervoltage transient in the supply voltage.

According to another aspect there is provided a device. The device may be configured to provide undervoltage protection and may include a first low voltage isolated transistor coupled in forward bias with respect to a power supply. The device of this example may also include a second low voltage isolated transistor coupled in series with the first low voltage isolated transistor and in reverse bias with respect to the power supply voltage.

According to another aspect there is provided a method. The method may include coupling a first low voltage isolated transistor in forward bias with respect to a power supply. The method of this example may also include coupling a second low voltage isolated transistor in series with the first low voltage isolated transistor and in reverse bias with respect to the power supply voltage.

As used herein, use of the term “nominal” or “nominally” when referring to an amount means a designated or theoretical amount that may vary from the actual amount. The term “switches” may be embodied as MOSFET switches (e.g. individual NMOS and PMOS elements), BJT switches, diodes and/or other switching circuits known in the art. In addition, “circuitry” or “circuit”, as used in any embodiment herein, may comprise, for example, singly or in any combination, hardwired circuitry, programmable circuitry, state machine circuitry, and/or circuitry that is included in a larger system, for example, elements that may be included in an integrated circuit.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A voltage transient protection system comprising:
undervoltage protection circuitry coupled in parallel with electronic circuitry configured to receive a supply voltage from a power supply,
said undervoltage protection circuitry being configured to reduce undervoltage current resulting from an undervoltage transient in said supply voltage.

2. The system of claim 1, wherein said undervoltage protection circuitry comprises:
a first low voltage isolated transistor coupled in forward bias with respect to said power supply; and
a second low voltage isolated transistor coupled in series with said first low voltage isolated transistor and in reverse bias with respect to said power supply voltage.

3. The system of claim 2, wherein said undervoltage protection circuitry further comprises:
a resistor coupled between a gate of said first low voltage isolated transistor and said power supply, said resistor configured to limit current flow to said gate of said first low voltage isolated transistor during an overvoltage event.

4. The system of claim 2, further comprising:
overvoltage protection circuitry coupled in series to said second low voltage transistor.

5. The system of claim 2, wherein said first low voltage isolated transistor and said second low voltage isolated transistor are negative metal oxide semiconductor (NMOS) transistors.

6. The system of claim 5, wherein substrate terminals of said first low voltage isolated transistor and said second low voltage isolated transistor are coupled to a ground reference potential.

7. The system of claim 5, wherein an n-type isolation terminal of said first low voltage isolated transistor is coupled to an n-type isolation terminal of said second low voltage isolated transistor.

8. The system of claim 2, wherein a breakdown voltage of said first low voltage isolated transistor is based on an undervoltage tolerance of said electronic circuitry.

9. The system of claim 4, wherein a breakdown voltage of said second low voltage isolated transistor is based on an overvoltage tolerance of said electronic circuitry and is further based on a breakdown voltage of said overvoltage protection circuitry.

10. An undervoltage protection circuit comprising:
a first low voltage isolated transistor coupled in forward bias with respect to a power supply; and
a second low voltage isolated transistor coupled in series with said first low voltage isolated transistor and in reverse bias with respect to said power supply voltage.

11. The circuit of claim 10, further comprising a resistor coupled between a gate of said first low voltage isolated transistor and said power supply, said resistor configured to limit current flow to said gate of said first low voltage isolated transistor during an overvoltage event.

12. The circuit of claim 10, wherein said first low voltage isolated transistor and said second low voltage isolated transistor are NMOS transistors.

13. The circuit of claim 12, wherein substrate terminals of said first low voltage isolated transistor and said second low voltage isolated transistor are coupled to a ground reference potential.

14. The circuit of claim 12, wherein an n-type isolation terminal of said first low voltage isolated transistor is coupled to an n-type isolation terminal of said second low voltage isolated transistor.

15. A method for providing undervoltage protection comprising:
coupling a first low voltage isolated transistor in forward bias with respect to a power supply; and
coupling a second low voltage isolated transistor in series with said first low voltage isolated transistor and in reverse bias with respect to said power supply voltage.

16. The method of claim 15, further comprising coupling a resistor between a gate of said first low voltage isolated transistor and said power supply, said resistor configured to limit current flow to said gate of said first low voltage isolated transistor during an overvoltage event.

17. The method of claim 15, wherein said first low voltage isolated transistor and said second low voltage isolated transistor are NMOS transistors.

18. The method of claim 15, further comprising coupling substrate terminals of said first low voltage isolated transistor and said second low voltage isolated transistor to a ground reference potential.

19. The method of claim 15, further comprising coupling an n-type isolation terminal of said first low voltage isolated transistor is to an n-type isolation terminal of said second low voltage isolated transistor.
